(19) United States
(12) Patent Application Publication
(10) Pub. No.: US 2025/0063463 A1
(43) Pub. Date: Feb. 20, 2025

(54) TECHNOLOGIES FOR STANDALONE OPERATION FOR NETWORK SLICING

(71) Applicant: Apple Inc., Cupertino, CA (US)

(72) Inventors: Alosious Pradeep Prabhakar, Singapore (SG); Muthukumaran Dhanapal, San Diego, CA (US)

(73) Assignee: Apple Inc., Cupertino, CA (US)

(21) Appl. No.: 18/774,399

(22) Filed: Jul. 16, 2024

Related U.S. Application Data
(60) Provisional application No. 63/520,404, filed on Aug. 18, 2023.

(51) Int. Cl. H04W 40/22; H04W 60/04; H04W 84/12

(52) U.S. Cl. CPC H04W 40/22; H04W 60/04; H04W 84/12

(57) ABSTRACT

Techniques are described herein for network slice availability based de-prioritization. An example, method includes receiving user equipment (UE) routing selection policy (URSP) information. The method further includes starting an application associated with a network slice while registered with a standalone (SA) network. The method further includes evaluating routing selection descriptor information in the URSP information to determine an availability of the network slice of the SA network. The method further includes determining whether to de-prioritize the SA network based on a determination of availability of the network slice as indicated by the routing selection descriptor information.

### CROSS-REFERENCES TO RELATED APPLICATIONS

This application claims priority to and the benefit of U.S. Provisional Application No. 63/520,404, filed on Aug. 18, 2023, which is incorporated by reference in its entirety for all purposes.

### BACKGROUND

Cellular communications can be defined in various standards to enable communications between a user equipment and a cellular network. For example, a long-term evolution (LTE) network and Fifth generation mobile network (5G) are wireless standards that aim to improve upon data transmission speed, reliability, availability, and more.

### BRIEF DESCRIPTION OF THE DRAWINGS

FIG. 1 is an illustration of a system for network slice-based prioritization and de-prioritization decisions, according to one or more embodiments.

FIG. 2 is a signaling diagram for a network slice-based de-prioritization decision, according to one or more embodiments.

FIG. 3 is a signaling diagram for a network slice-based de-prioritization decision, according to one or more embodiments.

FIG. 4 is a signaling diagram for network slice-based de-prioritization and re-prioritization decisions, according to one or more embodiments.

FIG. 5 is a signaling diagram for a network slice-based re-prioritization decision, according to one or more embodiments.

FIG. 6 is a signaling diagram for a network slice-based re-prioritization decision, according to one or more embodiments.

FIG. 7 is a table for different de-prioritization decisions, according to one or more embodiments.

FIG. 8 is another table for different de-prioritization decisions, according to one or more embodiments.

FIG. 9 is a process flow for de-prioritization and prioritization, according to one or more embodiments.

FIG. 10 is a process flow for a de-prioritization decision, according to one or more embodiments.

FIG. 11 is a process flow for a re-prioritization decision, according to one or more embodiments.

FIG. 12 illustrates an example of receive components, in accordance with some embodiments.

FIG. 13 illustrates an example of a UE, in accordance with some embodiments.

FIG. 14 illustrates an example of a network node, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, 5G NR, or 6G. In general, 3GPP access refers to various types of cellular access technologies.

The term “Non-3GPP Access” refers to any accesses (e.g., radio access technologies) that are not specified by 3GPP standards. These accesses include, but are not limited to, WiMAX, CDMA2000, Wi-Fi, WLAN, or fixed networks. Non-3GPP accesses may be split into two categories, “trusted” and “untrusted.” Trusted non-3GPP accesses can interact directly with an evolved packet core (EPC) or a 5G core (5GC), whereas untrusted non-3GPP accesses interwork with the EPC/5GC via a network entity, such as an Evolved Packet Data Gateway or a 5G NR gateway. In general, non-3GPP access refers to various types on non-cellular access technologies.

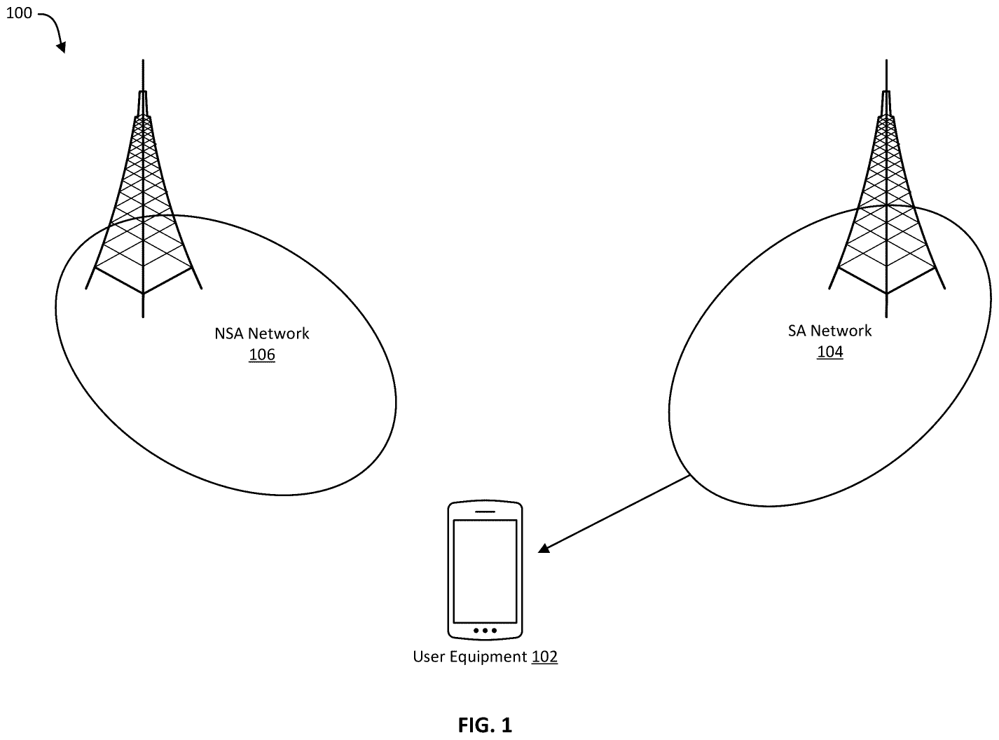

FIG. 1 is an illustration 100 of a system for network slice-based prioritization and de-prioritization decisions, according to one or more embodiments. A user equipment (UE) 102 can be camped on a standalone (SA) network 104 (e.g., a 5G network). The UE's control plane and data plane can be supported by the SA network 104. The UE 102 can be configured to de-prioritize the SA 104 network to a non-standalone (NSA) network 106 (having, e.g., 3G or LTE components), or to prioritize the NSA network 106 to the SA 104 based on various factors, such as bandwidth, signal strength, and battery life. For example, connection with a 5G network may drain a battery faster than a connection with a 4G network. Therefore, a UE may be configured to de-prioritize a 5G network to a 4G network based on the UE's remaining battery life. However, prioritization and de-prioritization do not account for network slice availability. The UE 102 may be camped on the cell of the SA network 104 and running an application supported by a network slice of the SA network 104. A network slice can be a set of resources that are assigned to a virtualized network service. For whatever reason, the network slice may become unavailable to the UE 102. UEs can currently be configured to always have SA ON, rather than for example, 5G AUTO, or LTE, if the network has deployed a network slice for the UE and no de-prioritizations are occurring. This can lead to a large number of UEs connected to the SA network 104. This can also lead to draining the UE's battery life faster than if the UE 102 was connected to the NSA network 106. As described herein, the UE 102 can account for network slice availability to determine whether to prioritize to the SA network 104 from the NSA network 106 or to de-prioritize to the NSA network 106 from the SA network 104.

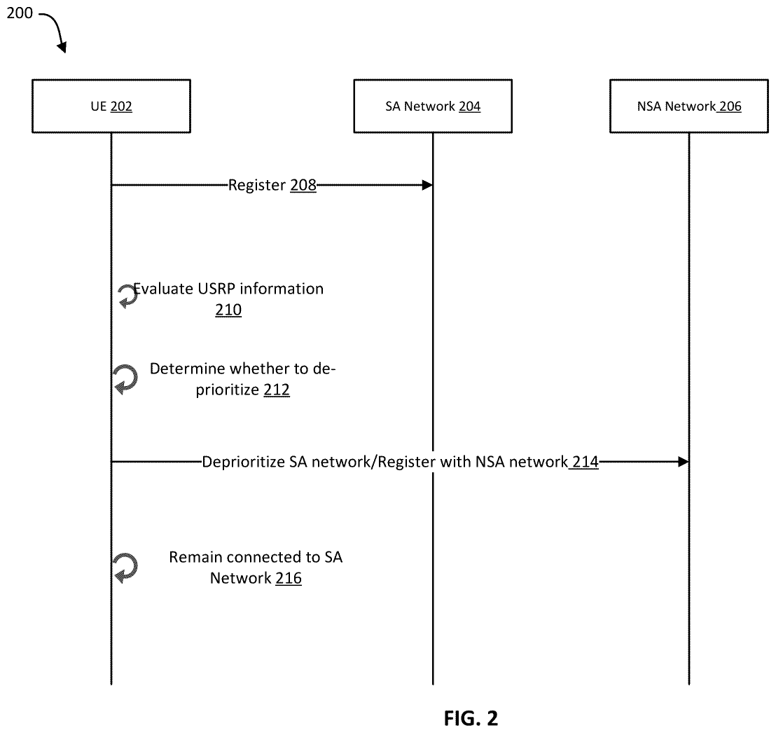

FIG. 2 is a signaling diagram 200 for a network slice-based de-prioritization decision, according to one or more embodiments. As illustrated, a UE 202 can be in operable communication with a SA network 204 and an NSA 206. At 208, the UE 202 can register with the SA network 204. During the registration procedure, the UE can transmit a non-access stratum (NAS) message to the SA network 204 that includes network slice selection assistance information (NSSAI), which can include a set of requested single(S)-NSSAIs. The SA network 204 can return allowed NSSAI and configured NSSAI to the UE 202 as part of a registration accept message.

The SA network 204 can also provide the UE 202 with the UE route selection policy (URSP). In some instances, the SA network 204 can either provide the URSP to the UE 202 without the UE 202 specifically asking for the URSP. In other instances, the SA network 204 can either provide the URSP to the UE 202 in response to a request from the UE 202. The URSP can include traffic descriptors and a route selection descriptor list for providing the UE 202 with data traffic rules to be applied for applications running in the UE and supported by a network slice. A route selection descriptor can include route selection validation criteria, where a route selection description may be invalid unless all of the criteria are met. The UE 202 can be configured to make a prioritization or de-prioritization determination based on the URSP.

At 210, the UE 202 can evaluate the URSP information, and in particular the route selection validation criteria. It is possible that the UE 202 has started an application since registering with the SA network 204 at 208, or the UE 202 may not have started an application. In either case, the UE 202 can evaluate the route selection validation criteria and continuously or periodically determine whether a condition has been met to indicate that one or more the route selection validation criteria is no longer met.

At 212, the UE 202 can determine whether to de-prioritize the SA network 204 to the NSA network 206 or remain with the SA network 204 based on the evaluation of the URSP. One route selection validation criteria can be a time window that indicates that an S-NSSAI is supported during a time range (e.g., 9:00 am-5:00 pm). The UE 202 can periodically determine the current time, and if the UE 202 is running an application supported by an S-NSSAI, determine whether the current time is outside of the applicable time window. If the current time is outside the time window indicated in the URSP, the UE 202 can determine to de-prioritize the SA network 204 to the NSA network 206 at 214. If, however, the current time is not outside the time window, the UE 202 can determine to remain connected to the SA network 204 at 216, provided that there are no other conditions for de-prioritization.

Another route selection validation criteria can be location criteria, in which the URSP can indicate that the S-NSSAI is supported within a geofence. A geofence can be a geographic boundary that defines an area of land. The UE 202 can periodically use a location service (e.g., a global positioning system (GPS)) to determine the current location of the UE 202. The UE 202 can further compare the UE's current location to the geofence indicated by the URSP. If the UE 202 is located outside of the geofence, the UE 202 can determine to de-prioritize the SA network 204 to the NSA network 206 at 214. If the UE 202 is located within the geofence, the UE 202 determine to remain connected to the UE at 216, provided that there are no other conditions for de-prioritization.

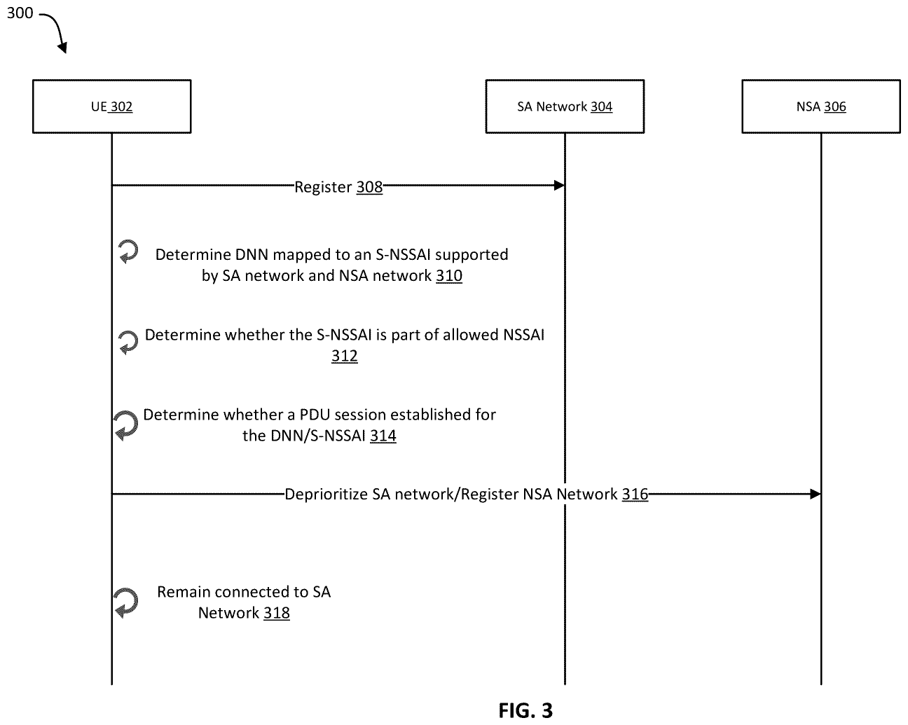

FIG. 3 is a signaling diagram 300 for a network slice-based de-prioritization decision, according to one or more embodiments. As illustrated, a UE 302 can be in operable communication with a SA network 304 and an NSA network 306. At 308, the UE 302 can register with the SA network 304. During the registration procedure, the UE 302 can transmit a NAS message to the SA network 304 that includes NSSAI, which can include a set of requested S-NSSAIs. The SA network 304 can return allowed NSSAI and configured NSSAI to the UE 302 as part of a registration accept message. In addition, the SA can provide configuration information for mapping the UE 302 to a configured data network name (DNN) that can be used to route data traffic to a particular S-NSSAI. In these instances, the DNN can be supported by the SA network 304 and the NSA network 306.

At 310, the UE 302 can determine whether the DNN is supported by the SA network 304 and the NSA network 306. For example, the UE 302 can make the determination based on information included in a mapped bearer context information element (IE). If the DNN is not supported by the NSA network 306, the UE 302 can remain connected to the SA network 304 at 318.

If the DNN is supported by the SA network 304 and the NSA network 306, the UE 302 can determine whether the S-NSSAI mapped to the DNN is part of the allowed NSSAI at 312. If, the S-NSSAI mapped to the DNN is not part of the allowed NSSAI at 312, the UE 302 can remain connected to the SA network 304 at 318.

If the S-NSSAI mapped to the DNN is part of the allowed NSSAI, the UE 302 can determine whether there is a packet data unit (PDU) session associated with the DNN and S-NSSAI at 314. If the UE 302 determines that there is an established PDU session associated with the DNN and S-NSSAI, the UE 302 can remain connected to the SA network 304 at 318.

If the UE 302 determines that there is no PDU session associated with the DNN and S-NSSAI, the UE can de-prioritize the SA network 304 and connect with the NSA network 306 at 316.

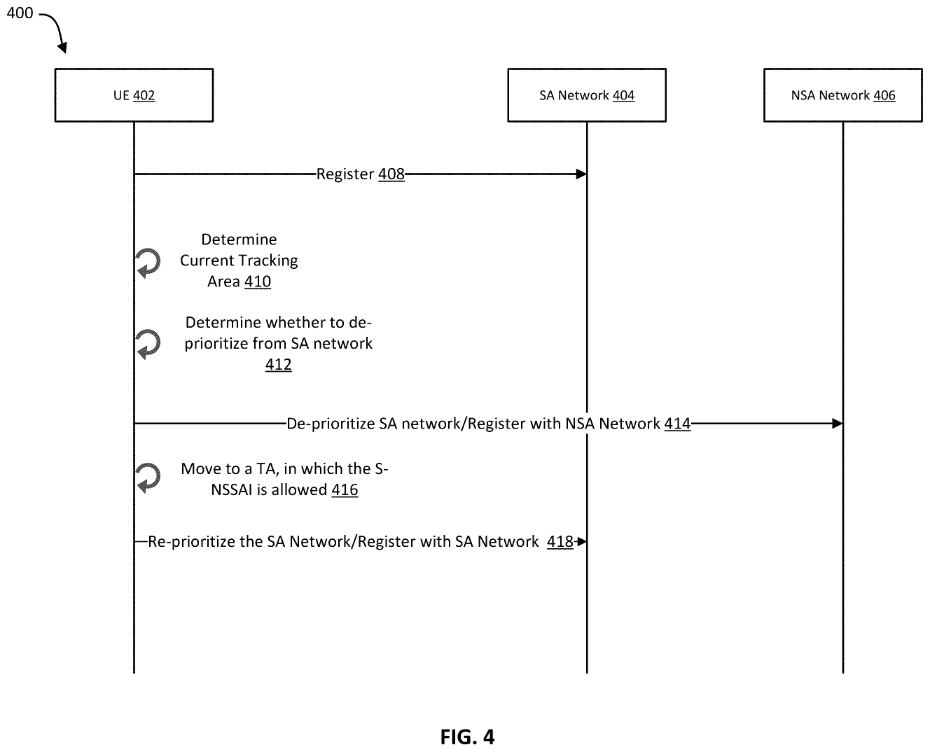

FIG. 4 is a signaling diagram 400 for network slice-based de-prioritization and re-prioritization decisions, according to one or more embodiments. As illustrated, a UE 402 can be in operable communication with a SA network 404 and an NSA network 406. At 408, the UE 402 can register with the SA network 404. During the registration procedure, the UE can transmit a NAS message to the SA network 304 that includes NSSAI, which can include a set of requested S-NSSAIs. The SA network 404 can return allowed NSSAI, rejected NSSAI, and configured NSSAI to the UE 402 as part of a registration accept message. Under 3GPP release 15 and 16, the UE 402 does not have information as to whether the rejected NSSAI are tracking area (TA) specific or rejected over an entire public land mobile network (PLMN), whether the UE 402 can re-request the rejected NSSAI in another TA.

As described herein, the UE 402 can maintain a record of the allowed NSSAI and the rejected NSSAI, and a current TA. The UE 402 can further maintain information as to whether a rejected NSSAI is TA-specific or rejected over an entire PLMN. This information can be received as part of the “Rejected NSSAI” cause code in the Registration Accept messaging. The UE 402 can further receive information indicating that the UE is moving from the current TA to a new TA (e.g., during a registration process with a cell in the new TA).

At 410, the UE 402 can determine the current TA. A TA can be identified by a tracking area code (TAC) or a tracking area identity (TAI).

At 412, the UE can determine whether to de-prioritize the SA network 404 based on the current TA. In particular, the UE 402 can make the determination based on whether the UE is in the current TA, in which the S-NSSAI is rejected. For example, the UE 402 can make the determination based on the UE 402 having requested an S-NSSAI and the UE 402 is in a TA, in which the S-NSSAI is rejected. In this instance, the UE 402 can de-prioritize the SA network 404. The UE 402 can further register with the NSA network 406 at 414. In this instance, the UE 402 can remain registered with the NSA network 406.

At 416, the UE 402 can move to a TA, in which the S-NSSAI is allowed. At 418, the UE 402 can re-prioritize the SA network 404. The UE 402 can further register with the SA network 404. The UE 402 can further include a request for the S-NSSAI rejected in the previous TA in the registration request message.

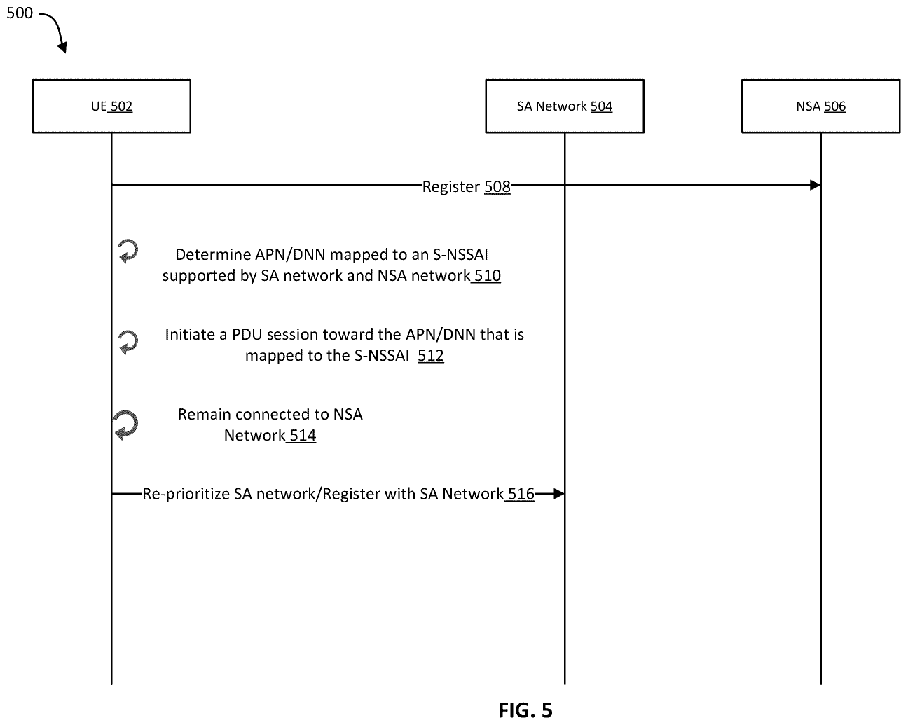

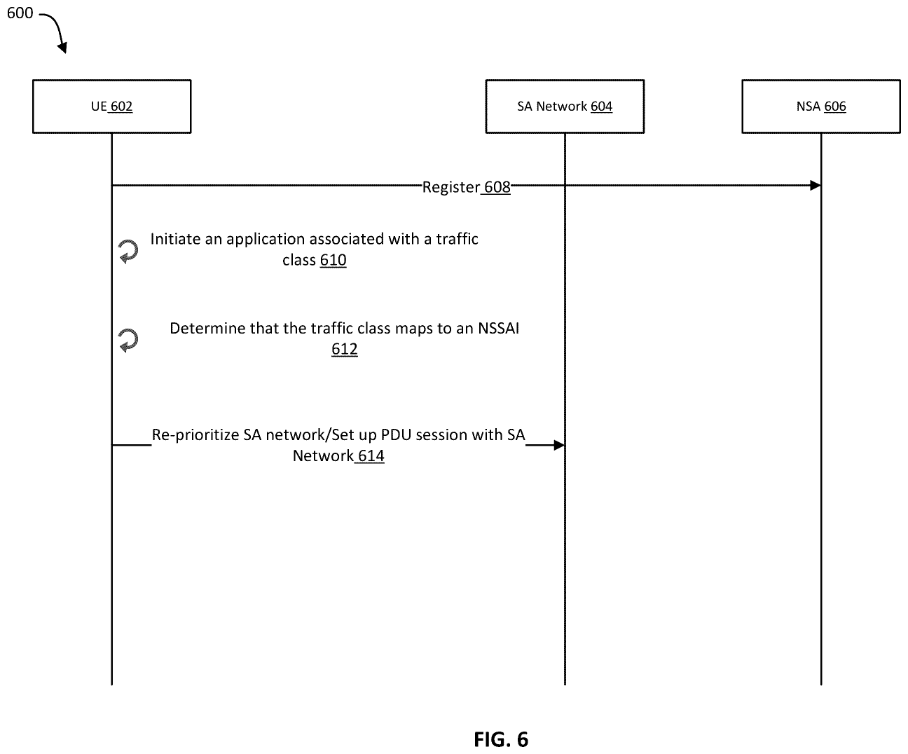

FIGS. 5 and 6 relate to scenarios in which the UE has de-prioritized the SA Network and registered with the NSA network. For example, the UE may have de-prioritized the SA network based on the conditions described in one of the figures above. The UE can re-prioritize the SA network based on the conditions described in the figures below.

FIG. 5 is a signaling diagram 500 for a network slice-based re-prioritization decision, according to one or more embodiments. As illustrated, a UE 502 can be in operable communication with a SA network 504 and an NSA 506. At 508, the UE 502 can register with the NSA network 506. The NSA network 506 can provide configuration information for mapping the UE 502 to a configured access point name (APN)/DNN, where the DNN is mapped to an S-NSSAI. In some instances, the APN/DNN can be supported by the SA network 504 and the NSA network 506.

At 510, the UE 502 can determine whether the APN/DNN is supported by the SA network 504 and the NSA network 506. For example, the UE 502 can make the determination based on information included in a mapped bearer context information element (IE).

At 512, the UE 502 can determine whether there is a PDU session associated with the APN/DNN and S-NSSAI. If the UE 502 determines that there is no PDU session associated with the APN/DNN and S-NSSAI, the UE 502 can remain connected to the NSA network 506 at 514.

If the UE 502 determines that there is a PDU session associated with the APN/DNN and S-NSSAI, the UE can re-prioritize the SA network 504. The UE 502 can further register with the SA network 506 at 516.

FIG. 6 is a signaling diagram 600 for a network slice-based re-prioritization decision, according to one or more embodiments. As illustrated, a UE 602 can be in operable communication with a SA network 604 and an NSA 606. At 608, the UE 602 can register with the NSA network 606. At 610, the UE 602 can initiate an application associated with a particular traffic class (e.g., a gaming or streaming traffic class). At 612, the UE 602 can determine that the traffic class maps to an NSSAI.

At 614, the UE 602 can re-prioritize the SA network based on the traffic class mapping to the NSSAI. In some instances, the UE 602 can re-prioritize the SA network based on the particular application invoked by the UE 602. The UE 602 can register with the SA network 604. The UE 602 can further set up a PDU session associated with the application for mapping to the NSSAI.

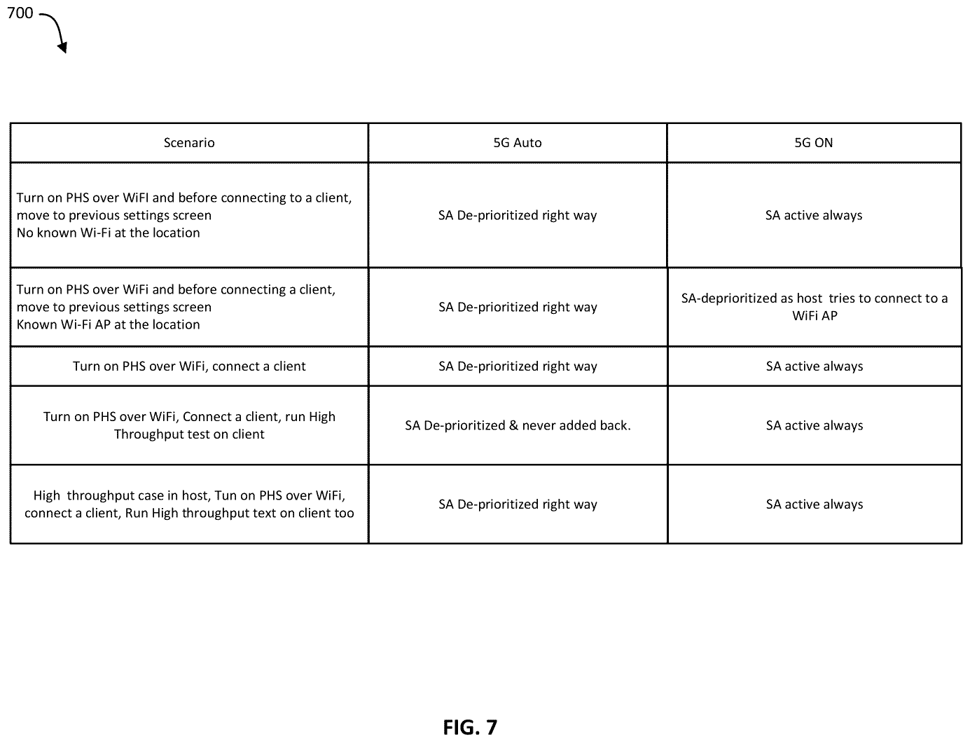

FIG. 7 is a table 700 for different de-prioritization decisions, according to one or more embodiments. Tethering can be a process for connecting with a network using a universal serial bus (USB) cable. A UE can use various modes and methods for connecting with a network. A 5G Auto mode can be a UE mode, in which the UE will switch from a 5G network to an LTE network based on the performance of the 5G network. A 5G ON mode is a UE mode, in which the UE will use the 5G network, if available. A personal hotspot (sometimes referred to as wireless local area network (WLAN) tethering) can be a condition in which the UE is connected to a network using a WLAN, such as WiFi®. A cellular-preferred mode is a UE mode, in which the UE will use a cellular network when a cellular network and a WLAN are available. A WLAN-preferred mode is a UE mode, in which the UE will use a WLAN when a cellular network and a WLAN are available.

In some instances, the UE can de-prioritize an SA network and connect to an NSA network based on detecting one or more conditions have been met. If a UE is in a 5G ON mode, the UE can de-prioritize the SA network and register with the NSA network based on the UE being used for WiFi calling. If the UE is in a cellular-preferred mode, a UE user may prefer to remain on the SA network for higher performance. Furthermore, aggressively disconnecting from the SA network due to the WLAN connection can cause a negative impact on the user's UE experience. If the UE is in a 5G Auto mode, the UE can de-prioritize the SA network and register with the NSA network in the instance the UE enables tethering. This can lead to slow throughput performance, even in a high throughput scenario. The table 700 describes five different scenarios and whether a UE de-prioritizes the SA network based on UE being in a 5G Auto mode or a 5G ON mode.

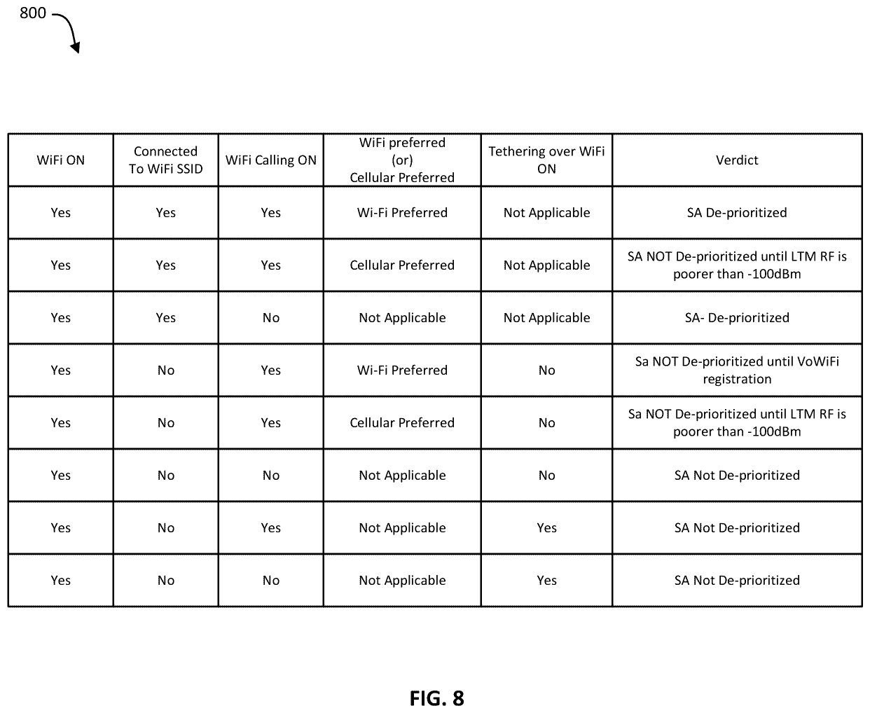

FIG. 8 is table 800 for different de-prioritization decisions, according to one or more embodiments. As described in the table 800, for a UE in a cellular-preferred mode, the UE does not de-prioritize the SA network unless the radio frequency (RF) of the NSA network is below a threshold dBM (e.g., −100 dBm). For example, the UE can periodically scan for NSA RF conditions while in a radio resource control (RRC)-connected mode. For example, the UE can take the measurement during a measurement gap even if the MeasObject for LTE is not configured. In another example, the UE can periodically scan for the LTE RF conditions while in an RRC-IDLE state. For example, the UE can perform a scan every thirty seconds of a previously camped LTE frequency or the most important frequency for the serving PLMN.

For a UE in a WLAN-preferred mode (e.g., WiFi preferred), the UE can be configured to not aggressively de-prioritize the SA network. Rather the UE can be configured to maintain the SA network. For example, WiFi tethering is a procedure that is mostly used to share internet with nearby devices, and can consume data for some high throughput cases. Aggressively prioritizing the SA network could lead to a poor user experience in this case. In some instances, the UE can still de-prioritize the SA network based on detecting that one or more conditions have been met. For example, the UE can detect that after “x” minutes, the UE is not using high throughput data.

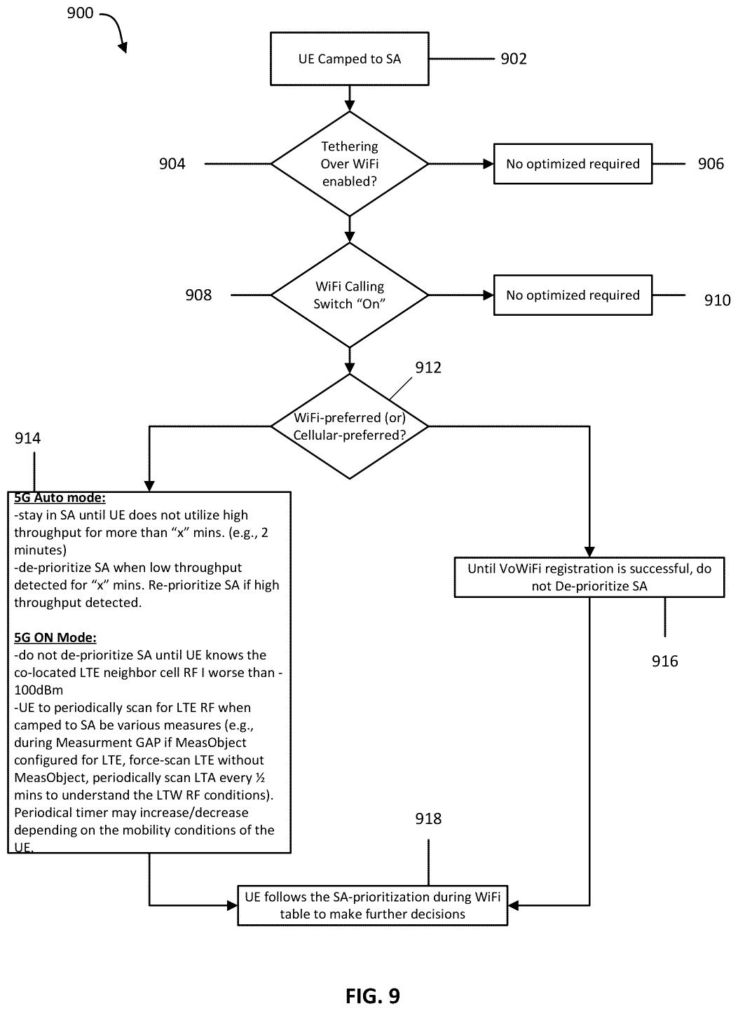

FIG. 9 is a process flow 900 for de-prioritization and prioritization, according to one or more embodiments. The process flow describes the verdicts indicated in FIG. 8 according to one or more embodiments. At 904, the UE can determine whether WiFi tethering is enabled for the UE. At 904, if WiFi tethering is not enabled for the UE, no optimizations are required at 906. If WiFi tethering is enabled, the process can proceed to 908.

At 908, the UE can determine whether WiFi calling is enabled for the UE. If WiFi calling is not enabled for the UE, no optimizations are needed at 910. At 912, the UE can determine whether the UE is in a WiFi-preferred mode or a cellular-preferred mode. If the UE is in a WiFi-preferred mode, the process can proceed to 914. At 914, the UE can further determine whether the UE is in 5G Auto mode or 5G ON mode. If the UE is in 5G auto mode, the UE can maintain the SA network until UE does not utilize high throughput for more than “y” mins. (e.g., 2 minutes). The UE can de-prioritize the SA network when the UE detects low throughput detects for more than “y” mins. The UE can further re-prioritize the SA network if high throughput is detected.

If the UE is in 5G ON mode, the UE does not de-prioritize the SA network until the UE determines that a co-located LTE neighbor cell RF is below a threshold dBM. The UE can periodically scan for LTE RF when camped to SA be various measures (e.g., during a measurement GAP if MeasObject is configured for LTE, force-scan LTE without MeasObject, or periodically scan LTA every thirty seconds to understand the LTW RF conditions). The UE's periodical timer may increase/decrease depending on the mobility conditions of the UE. The process can then proceed to 918.

If cellular calling is enabled, the UE does not de-prioritize the SA network until a voice over (VO) WiFi registration is successful at 916. The process can then proceed to 918.

At 918, the UE can follow the table 800 for further SA network de-prioritization during WiFi for subsequent de-prioritization and re-prioritization decisions.

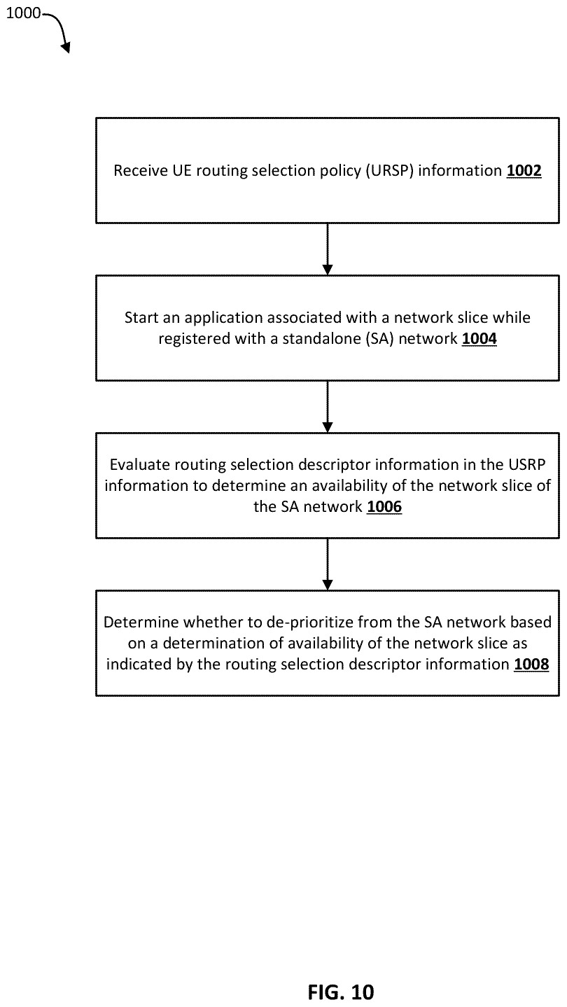

FIG. 10 is a process flow for a de-prioritization decision, according to one or more embodiments. At 1002, the process can include a UE receiving UE routing selection policy (URSP) information from an SA network.

At 1004, the process can include the UE starting an application associated with a network slice while registered with the SA network.

At 1006, the process can include the UE evaluating routing selection descriptor information in the URSP information to determine an availability of the network slice of the SA network. Evaluating the routing selection descriptor information in the URSP information can include accessing route selection validation criteria based on the routing selection descriptor information in the URSP information. The UE can determine that the network slice is unavailable outside of a time window based on the route selection validation criteria. The UE can determine that a current time is outside of the time window.

Evaluating the routing selection descriptor information in the URSP information can also include accessing route selection validation criteria based on the routing selection descriptor information in the URSP information. The UE can determine that the network slice is unavailable outside of a geofence. The UE can determine that the UE is outside of the geofence.

At 1008, the process can include the UE determining whether to de-prioritize the SA network based on a determination of availability of the network slice as indicated by the routing selection descriptor information. The UE can further de-prioritize the SA network based on the determination of availability of the network slice. The UE can register with a non-standalone (NSA) network.

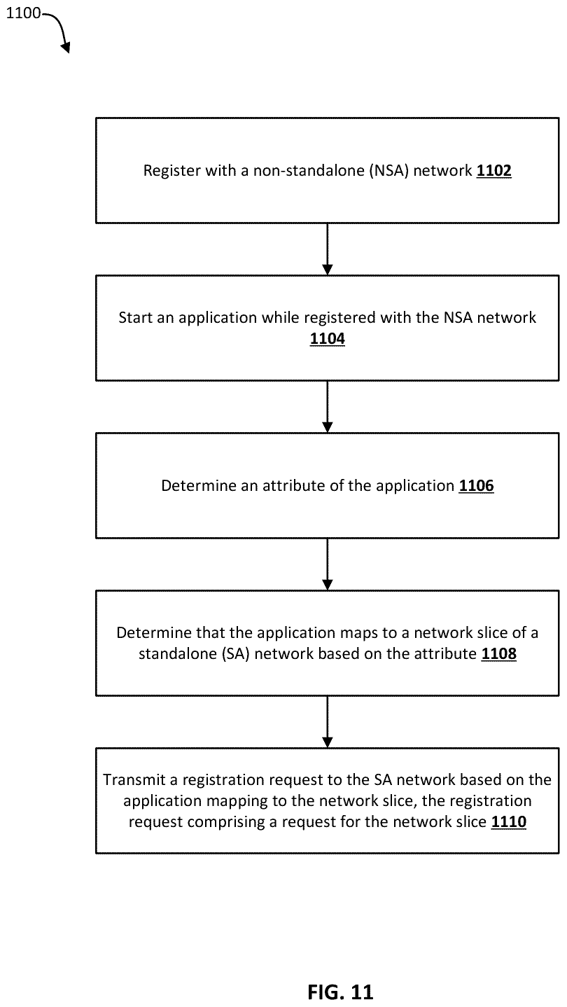

FIG. 11 is a process flow for a re-prioritization decision, according to one or more embodiments. At 1102, the process can include a UE registering with an NSA network.

At 1104, the process can include the UE starting an application while registered with the NSA network.

At 1106, the process can include the UE determining an attribute. The attribute may be associated with the application. For example, the attribute may be a traffic class of the application or an identity of the application.

At 1108, the process can include the UE determining that the application maps to a network slice of a SA network based on the attribute. For example, the mapping information can be included information provided by the network during a registration procedure.

At 1110, the process can include the UE transmitting a registration request to the SA network based on the application mapping to the network slice. The registration request may include a request for the network slice.

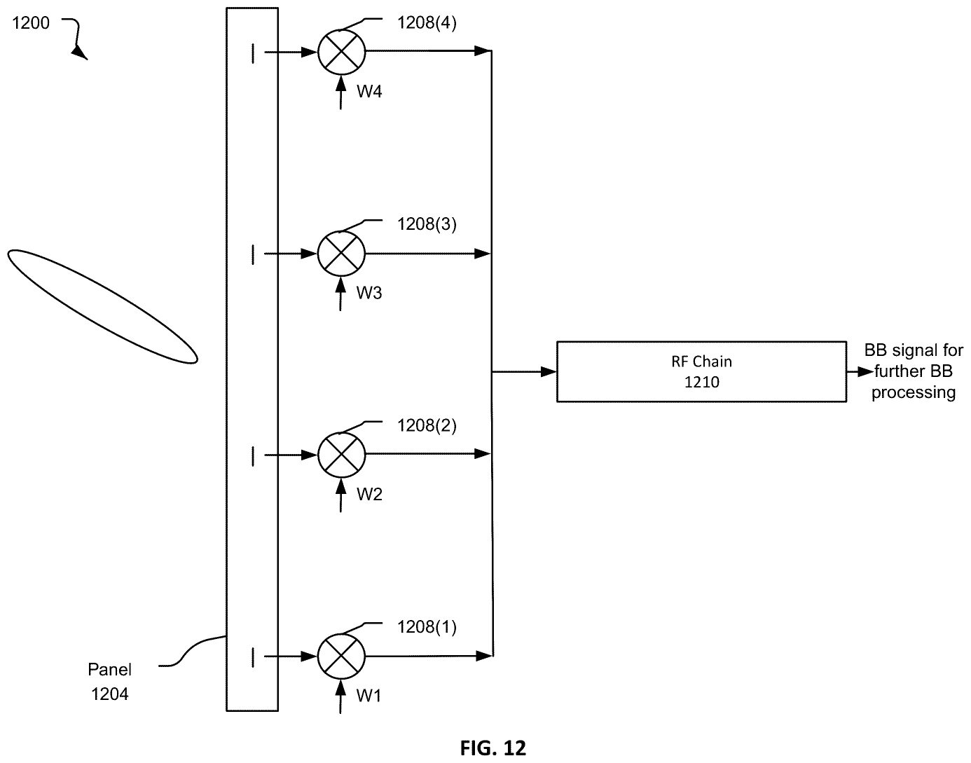

FIG. 12 illustrates receive components 1200 of a UE (e.g., UE 102), in accordance with some embodiments. The receive components 1200 may include an antenna panel 1204 that includes a number of antenna elements. The panel 1204 is shown with four antenna elements, but other embodiments may include other numbers.

The antenna panel 1204 may be coupled to analog beamforming (BF) components that include a number of phase shifters 1208(1)-1208(4). The phase shifters 1208(1)-1208(4) may be coupled with a radio-frequency (RF) chain 1213. The RF chain 1213 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (e.g., W1-W4), which may represent phase shift values, to the phase shifters 1208(1)-1208(4) to provide a receive beam at the antenna panel 1204. These BF weights may be determined based on the channel-based beamforming.

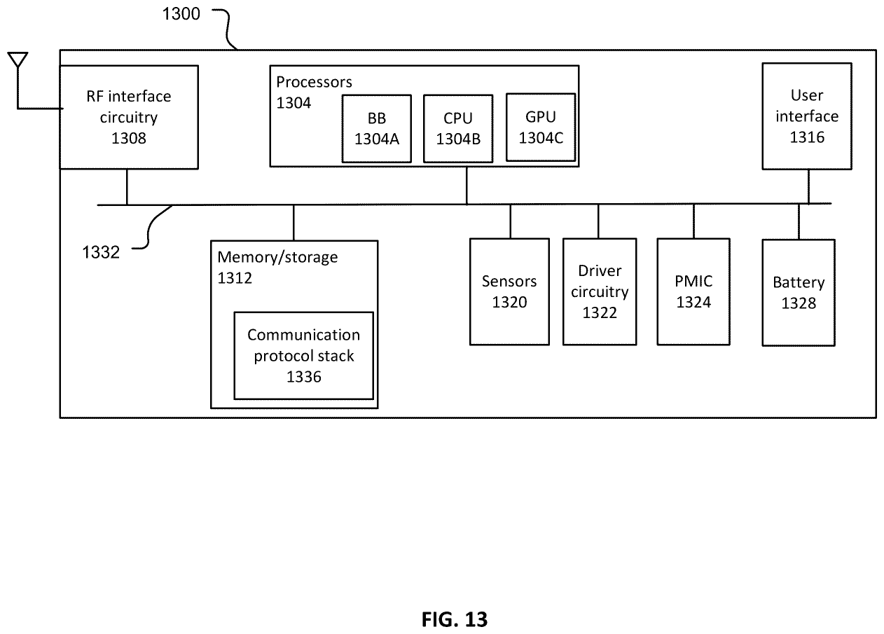

FIG. 13 illustrates a UE 1300, in accordance with some embodiments. The UE 1300 may be similar to and substantially interchangeable with the UE described with respect to FIG. 12.

Similar to that described above with respect to UE 1300, the UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1300 may include processors 1304, RF interface circuitry 1308, memory/storage 1313, user interface 1316, sensors 1320, driver circuitry 1322, power management integrated circuit (PMIC) 1324, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangements of the components shown may occur in other implementations.

The components of the UE 1300 may be coupled with various other components over one or more interconnects 1332, which may represent any type of interface, input/output, bus (local, system, or expansion), transmission line, trace, optical connection, etc. that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1313 to cause the UE 1300 to perform operations as described herein.

In some embodiments, the baseband processor circuitry 1304A may access a communication protocol stack 1336 in the memory/storage 1313 to communicate over a 3GPP compatible network. In general, the baseband processor circuitry 1304A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1313 may include any type of volatile or non-volatile memory that may be distributed throughout the UE 1300. In some embodiments, some of the memory/storage 1313 may be located on the processors 1304 themselves (for example, L1 and L2 cache), while other memory/storage 1313 is external to the processors 1304 but accessible thereto via a memory interface. The memory/storage 1313 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1308 may include transceiver circuitry and a radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1324 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1324.

In various embodiments, the RF interface circuitry 1308 may be configured to transmit/receive signals in a manner compatible with NR access technologies.

The antenna 1324 may include a number of antenna elements that each convert electrical signals into radio waves to travel through the air and to convert received radio waves into electrical signals. The antenna elements may be arranged into one or more antenna panels.

The antenna 1324 may have antenna panels that are omnidirectional, directional, or a combination thereof to enable beamforming and multiple input, multiple output communications. The antenna 1324 may include microstrip antennas, printed antennas fabricated on the surface of one or more printed circuit boards, patch antennas, phased array antennas, etc. The antenna 1324 may have one or more panels designed for specific frequency bands including bands in FR1 or FR2.

The user interface circuitry 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1300.

The sensors 1320 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within, or connected to, the UE 1300. For example, driver circuitry 1322 may include a display driver to control and allow access to a display device, a touchscreen driver to control and allow access to a touchscreen interface, sensor drivers to obtain sensor readings of sensor circuitry 1320 and control and allow access to sensor circuitry 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

In some embodiments, the PMIC 1324 may control, or otherwise be part of, various power saving mechanisms of the UE 1300. For example, if the platform UE is in an RRC_Connected state, where it is still connected to the radio access network (RAN) node as it expects to receive traffic shortly, then it may enter a state known as Discontinuous Reception Mode (DRX) after a period of inactivity. During this state, the UE 1300 may power down for brief intervals of times and thus save power. If there is no data traffic activity for an extended period of time, then the UE 1300 may transition off to an RRC_Idle state, where it disconnects from the network and does not perform operations such as channel quality feedback, handover, etc. The UE 1300 goes into a very low power state and it performs paging where again it periodically wakes up to listen to the network and then powers down again. The UE 1300 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1328 may power the UE 1300, although in some examples the UE 1300 may be mounted deployed in a fixed location, and may have a power supply coupled to an electrical grid. The battery 1328 may be a lithium ion battery, a metal-air battery, such as a zinc-air battery, an aluminum-air battery, a lithium-air battery, and the like. In some implementations, such as in vehicle-based applications, the battery 1328 may be a typical lead-acid automotive battery.

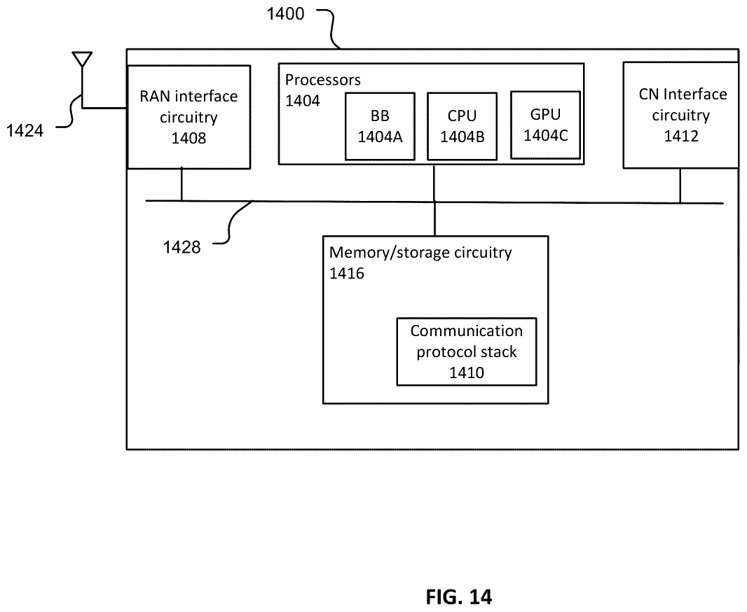

FIG. 14 illustrates a network node 1400, in accordance with some embodiments. The network node 1400 may include processors 1404, RF interface circuitry 1408, core network (CN) interface circuitry 1413, and memory/storage circuitry 1416. The network node 1400 can be a node of a RAN or a CN.

The components of the network node 1400 may be coupled with various other components over one or more interconnects 1428.

The processors 1404, RF interface circuitry 1408, memory/storage circuitry 1416 (including communication protocol stack 1410), antenna 1424, and interconnects 1428 may be similar to like-named elements shown and described with respect to FIG. 12.

The CN interface circuitry 1413 may provide connectivity to a CN, for example, a 4th Generation Core network (5GC) using a 4GC-compatible network interface protocol such as carrier Ethernet protocols, or some other suitable protocol. Network connectivity may be provided to/from the network node 1400 via a fiber optic or wireless backhaul. The CN interface circuitry 1413 may include one or more dedicated processors or FPGAs to communicate using one or more of the aforementioned protocols. In some implementations, the CN interface circuitry 1413 may include multiple controllers to provide connectivity to other networks using the same or different protocols.

As indicated above, in other embodiments, the network node 1400 can be a CN node. In these embodiments, the network node 1400 include RF interface circuitry 1408 for connectivity with a RAN. The RF interface circuitry 1408 may include one or more dedicated processors or FPGAs to communicate using one or more of the aforementioned protocols. In some implementations, the RF interface circuitry 1408 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further example embodiments are provided.

Example 1 includes a method performed by a UE, the method comprising: receiving URSP information; starting an application associated with a network slice while registered with a SA network; evaluating routing selection descriptor information in the URSP information to determine an availability of the network slice of the SA network; and determining whether to de-prioritize the SA network based on a determination of availability of the network slice as indicated by the routing selection descriptor information.

Example 2 includes the method of example 1, wherein evaluating the routing selection descriptor information in the URSP information comprises: accessing route selection validation criteria based on the routing selection descriptor information in the URSP information; determining that the network slice is unavailable outside of a time window based on the route selection validation criteria; and determining that a current time is outside of the time window.

Example 3 includes the method of any of examples 1 and 2, wherein evaluating the routing selection descriptor information in the URSP information comprises: accessing route selection validation criteria based on the routing selection descriptor information in the URSP information; determining that the network slice is unavailable outside of a geofence; and determining that the UE is outside of the geofence.

Example 4 includes the method of any of examples 1-3, wherein the method further comprises: de-prioritizing from the SA network based on the determination of availability of the network slice; and registering with a non-standalone (NSA) network.

Example 5 includes a UE for performing any of examples 1-4.

Example 6 includes a computer-readable medium having stored thereon a sequence of instructions which, when executed, causes a processor to perform operations including a method described in or related to examples 1-4.

Example 7 includes method performed by a UE, the method comprising: registering with a SA network; receiving configuration information based on registering with the SA network; starting an application associated with a network slice while registered with the SA network; determining that the network slice of the SA network is an allowed network slice based on the configuration information; determining whether there is an existing PDU session associated with the allowed network slice; and determining whether to de-prioritize the SA network based on whether there is an existing PDU session associated with the allowed network slice.

Example 8 includes the method of example 7, wherein receiving configuration information based on registering with the SA network comprises: receiving Allowed NSSAI based on registering with the SA network, wherein the UE determines that the network slice is allowed based on the Allowed NSSAI.

Example 9 includes the method of any examples 7 and 8, wherein the method further comprises: determining that there is no existing PDU session mapped to the network slice; and determining to de-prioritize the SA network and switch to an NSA network based on determining that there is no existing PDU session mapped to the network slice.

Example 10 includes the method of any of examples 7-9, wherein the method further comprises: determining that there is an existing PDU session mapped to the network slice; and determining to not de-prioritize the SA network based on determining that there is the existing PDU session mapped to the network slice.

Example 11 includes the method of any of examples 7-10, wherein the method further comprises: receiving mapped EPS bearer contexts information; and determining that the UE can de-prioritize the SA network to a non-SA (NSA) based on the mapped EPS bearer contexts information.

Example 12 includes a UE for performing any of examples 7-11.

Example 13 includes a computer-readable medium having stored thereon a sequence of instructions which, when executed, causes a processor to perform operations including a method described in or related to examples 7-11.

Example 14 includes a UE, comprising: an interface; and processing circuitry, coupled with the interface, the processing circuitry to: register, via the interface, with a SA network; receive, via the interface, NSSAI based on registering with the SA network; start an application associated with a network slice while registered with the SA network; determine a first TA in which the UE is located; determine that the network slice is a rejected network slice based on the first TA and the NSSAI; and determine to de-prioritize the SA network based on determining that the network slice is the rejected network slice.

Example 15 includes the UE of example 14, wherein the processing circuitry further to: determine that the UE has moved from the first TA to a second TA; and generate a registration request to register with the SA network, wherein the registration requests comprises a request for the network slice; and transmit the registration request to the SA network.

Example 16 includes a method for performing any of examples 14 and 15.

Example 17 includes a computer-readable medium having stored thereon a sequence of instructions which, when executed, causes a processor to perform operations including a method described in or related to examples 14-15.

Example 18 includes a method performed by a user equipment, the method comprising: registering with a NSA network; determining that an APN is mapped to a network slice of a SA network; starting a PDN session for an application associated with the network slice while registered with the NSA network; and transmitting a registration request to the SA network based on starting the PDN session and determining that the APN is mapped to the network slice, the registration request comprising a request for the network slice mapped to the APN.

Example 19 includes the method of example 18, wherein the method further comprises: registering with the SA based on the registration request; and starting a PDU session mapped to the network slice.

Example 20 includes the method of and of examples 18 and 19, wherein the UE transmits the registration request to the SA based on the mapping of the APN to the network slice and independent of throughput speed.

Example 21 includes a method for performing any of examples 18-20.

Example 22 includes a computer-readable medium having stored thereon a sequence of instructions which, when executed, causes a processor to perform operations including a method described in or related to examples 18-20.

Example 23 includes a method performed by a UE, the method comprising: registering with a NSA network; starting an application while registered with the NSA network; determining an attribute of the application; determining that the application maps to a network slice of a SA network based on the attribute; transmitting a registration request to the SA network based on the application mapping to the network slice, the registration request comprising a request for the network slice.

Example 24 includes the method of example 23, wherein the attribute is a traffic class of the application.

Example 25 includes the method of example 24, wherein the attribute is an identity of the application.

Example 26 includes a UE for performing any of examples 23-25.

Example 27 includes a computer-readable medium having stored thereon a sequence of instructions which, when executed, causes a processor to perform operations including a method described in or related to examples 23-25.

Example 28 includes one or more computer-readable media having stored thereon a sequence of instructions which, when executed by one or more processors, cause a UE to: register with a (SA) network; determine whether a wireless local area network (WLAN) calling mode (e.g., WiFi calling mode) is enabled for the UE; determine whether a WLAN tethering mode (e.g., WiFi tethering mode) is enabled for the UE, and determine whether to remain registered to the SA network based on whether the WLAN calling mode is enabled for the UE and whether the WLAN tethering mode is enabled for the UE.

Example 29 includes the one or more computer-readable media of example 28, wherein the instructions, when executed, further cause the UE to: determine to remain registered to the SA network based on a determination that the WLAN calling mode is not enabled for the UE and a determination that the WLAN tethering mode is not enabled for the UE.

Example 30 includes the one or more computer-readable media of example 28, wherein the instructions, when executed, further cause the UE to: determine to remain registered to the SA network based on a determination that the WLAN calling mode is enabled for the UE and a determination that the WLAN tethering mode is enabled for the UE.

Example 30 includes the one or more computer-readable media of example 28, wherein the instructions, when executed, further cause the UE to: determine to remain registered to the SA network based on a determination that the WLAN calling mode is not enabled for the UE and a determination that the WLAN tethering mode is enabled for the UE.

Example 31 includes a UE for performing any of examples 28-30.

Example 32 includes a method for performing any of examples 28-30.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
receiving user equipment (UE) routing selection policy (URSP) information;
causing an application associated with a network slice to be started while registered with a standalone (SA) network;
evaluating routing selection descriptor information in the URSP information to determine an availability of the network slice of the SA network; and
determining whether to de-prioritize the SA network based on a determination of availability of the network slice as indicated by the routing selection descriptor information.

2. The method of claim 1, wherein evaluating the routing selection descriptor information in the URSP information comprises:
accessing route selection validation criteria based on the routing selection descriptor information in the URSP information;
determining that the network slice is unavailable outside of a window based on the route selection validation criteria; and
determining that a current time is outside of the time window, wherein determining whether to de-prioritize the SA network is further based on determining that the current time is outside of the time window.

3. The method of claim 1, wherein evaluating the routing selection descriptor information in the URSP information comprises:
accessing route selection validation criteria based on the routing selection descriptor information in the URSP information;
determining that the network slice is available within a time window based on the route selection validation criteria; and
determining that a current time is within the time window, wherein determining whether to de-prioritize the SA network is further based on determining that the current time is within the time window.

4. The method of claim 1, wherein evaluating the routing selection descriptor information in the URSP information comprises:
accessing route selection validation criteria based on the routing selection descriptor information in the URSP information;
determining that the network slice availability is based on a geofence; and
determining that a UE is outside of the geofence, wherein determining whether to de-prioritize the SA network is further based on determining that the UE is outside of the geofence.

5. The method of claim 1, wherein evaluating the routing selection descriptor information in the URSP information comprises:
accessing route selection validation criteria based on the routing selection descriptor information in the URSP information;
determining that the network slice availability is based on a geofence; and
determining that a UE is within the geofence, wherein determining whether to de-prioritize the SA network is further based on determining that the UE is within the geofence.

6. The method of claim 1, wherein the method further comprises:
de-prioritizing from the SA network based on the determination of availability of the network slice; and
registering with a non-standalone (NSA) network.

7. An apparatus comprising:
processing circuitry to:
cause a registration with a standalone (SA) network,
process configuration information based on registering with the SA network,
cause an application associated with a network slice to be started while registered with the SA network,
determine that the network slice of the SA network is an allowed network slice based on the configuration information,
determine whether there is an existing packet data unit (PDU) session associated with the allowed network slice, and
determine whether to de-prioritize the SA network based on whether there is an existing PDU session associated with the allowed network slice; and
memory coupled to the processing circuitry, the memory to store the configuration information.

8. The apparatus of claim 7, wherein receiving configuration information based on registering with the SA network comprises:
receiving Allowed Network Slice Selection Assistance Information (NSSAI) based on registering with the SA network, wherein the UE determines that the network slice is allowed based on the Allowed NSSAI.

9. The apparatus of claim 7, wherein the processing circuitry is further to:
determine that there is no existing PDU session mapped to the network slice; and
determine to de-prioritize the SA network and switch to a non-SA (NSA) network based on determining that there is no existing PDU session mapped to the network slice.

10. The apparatus of claim 7, wherein the processing circuitry is further to:
determine that there is an existing PDU session mapped to the network slice; and
determine to not de-prioritize the SA network based on determining that there is the existing PDU session mapped to the network slice.

11. The apparatus of claim 7, wherein the processing circuitry is further to:
process mapped evolved packet system (EPS) bearer contexts information; and
determine that the UE can de-prioritize the SA network to a non-SA (NSA) network based on the mapped EPS bearer contexts information.

12. The apparatus of claim 7, wherein the configuration information comprises data network name (DNN) information, and wherein the processing circuitry is further to:
determine whether the SA network supports a DNN, wherein determining whether to de-prioritize the SA network is based on the SA network supports the DNN.

13. The apparatus of claim 12, wherein determining whether the SA network supports a DNN is based on a mapped bearer context information element (IE).

14. The apparatus of claim 7, wherein the configuration information comprises (DNN) information, and wherein the processing circuitry is further to:
determine whether a non-SA network supports a DNN, wherein determining whether to de-prioritize the SA network is based on the non-SA network supports the DNN.

15. The apparatus of claim 14, wherein non-SA network does not support the DNN, and wherein the processing circuitry is further to:
determine to remain connected with the SA network.

16. One or more non-transitory, computer-readable media having stored thereon a sequence of instructions that, when executed, cause processing circuitry to:
cause a registration with a standalone (SA) network;
determine whether a wireless local area network (WLAN) calling mode is enabled for a user equipment (UE);
determine whether a WLAN tethering mode is enabled for the UE, and
determine whether to remain registered to the SA network based on whether the WLAN calling mode is enabled for the UE and whether the WLAN tethering mode is enabled for the UE.

17. The one or more non-transitory, computer-readable media of claim 16, wherein the instructions that, when executed, further cause the processing circuitry to:
determine to remain registered to the SA network based on a determination that the WLAN calling mode is not enabled for the UE and a determination that the WLAN tethering mode is not enabled for the UE.

18. The one or more non-transitory, computer-readable media of claim 17, wherein the instructions that, when executed, further cause the processing circuitry to:
determine to remain registered to the SA network based on a determination that the WLAN calling mode is enabled for the UE and a determination that the WLAN tethering mode is enabled for the UE.

19. The one or more non-transitory, computer-readable media of claim 16,
wherein the instructions that, when executed, further cause the processing circuitry to:
determine to remain registered to the SA network based on a determination that the WLAN calling mode is not enabled for the UE and a determination that the WLAN tethering mode is enabled for the UE.

20. The one or more non-transitory, computer-readable media of claim 16, wherein the sequence of instructions that, when executed, further cause the processing circuitry to:
cause a registration with a non-SA network based on the based on whether the WLAN calling mode is enabled for the UE and whether the WLAN tethering mode is enabled for the UE.
